(19) United States
(12) Patent Application Publication
(10) Pub. No.: US 2016/0286195 A1
(43) Pub. Date: Sep. 29, 2016

(54) ENGINE, SYSTEM AND METHOD FOR PROVIDING THREE DIMENSIONAL CONTENT AND VIEWING EXPERIENCE FOR SAME

(71) Applicant: Josh Lehman, New York, NY (US)

(72) Inventor: Josh Lehman, New York, NY (US)

(21) Appl. No.: 14/930,317

(22) Filed: Nov. 2, 2015

Related U.S. Application Data
(60) Provisional application No. 62/073,670, filed on Oct. 31, 2014.

(51) Int. Cl. H04N 13/00; G06T 19/00; H04N 13/02

(52) U.S. Cl. CPC H04N 13/0048; H04N 13/004; H04N 13/0055; H04N 13/0203; G06T 19/006

(57) ABSTRACT

The present invention includes at least engine, system and method for providing three-dimensional content and a viewing experience for same.

### CROSS-REFERENCE TO RELATED APPLICATION

The present invention claims priority to U.S. Provisional Application No. 62/073,670, filed Oct. 31, 2014, the entirety of which is incorporated by reference herein.

### BACKGROUND

1. Field of the Invention

The present invention relates to the three-dimensional viewing technologies, and, more particularly, to an engine, system and method for providing three dimensional content and a viewing experience for same.

2. Background of the Invention

In recent years, the three-dimensional cinema experience, also referred to as a “3D movie,” has returned to prominence. The human eyes are about two inches apart, and thus they see the same picture from slightly different angles. The brain then correlates these two images in order to gauge distance. This is called “binocular vision”. Historically, for 3D, the same scene is projected simultaneously from two different angles in two different colors, generally red and blue (or green). 3-D glasses, using colored filters, are then generally used to separate the two different images so that each image only enters one eye. The brain puts the two pictures back together, convincing the viewer that the image has depth, i.e., that the image is “3D.”

However, the time and effort spent on a 3D movie oftentimes does not provide a sufficient enhancement to the experience of watching the movie, such that many 3D movies fail to recoup the time, effort, and monies needed to make them. Moreover, the inadequacy of the 3D experiences made available in the home in the known art, and the consequent commercial failure of these efforts to provide the 3D experience at home, has largely limited any enhancement to the revenue generated by 3D technologies outside of initial theatrical runs.

3D provides the illusion that depth perception has been enhanced. Derived from stereoscopic-photography, a regular motion picture camera system is generally used to record the images as seen from two perspectives (or computer-generated imagery generates the two perspectives in post-production), and special projection hardware and/or eyewear is used to provide the illusion of depth when viewing the film. 3D films includes, but is not limited to, feature film theatrical releases; television broadcasts, direct-to-video films, 3D television and Blu-ray 3D, by way of example.

So-called “virtual reality,” or “VR,” is a subset of 3D technologies that endeavor to provide an enhanced 3D experience that may, for example, allow for enhanced revenue generation from at-home 3D technologies. However, most VR technologies are in their infancy, and the few that are not entail such significant levels of time, effort and expenditure to create or prepare content for the VR experience that the expense of such VR technologies will preclude the use thereof by all but the wealthiest and most technology savvy consumers.

VR is thus an immersive multimedia. It is typically a computer-simulated environment that can simulate physical presence in places in the real world or imagined worlds. Virtual reality can recreate sensory experiences, including virtual taste, sight, smell, sound, touch, etc. Most current virtual reality environments are primarily visual experiences, displayed either on a computer screen or through special stereoscopic displays, but some simulations include additional sensory information, such as sound provided through speakers or headphones. Some advanced haptic systems now include tactile information, generally known as force feedback, in medical, gaming and military applications. Furthermore, virtual reality covers remote communication environments which provide virtual presence of users with the concepts of telepresence and tele-existence or a virtual artifact (VA), either through the use of standard input devices such as a keyboard and mouse, or through multimodal devices such as a wired glove, the Polhemus, and omnidirectional treadmills. The simulated environment can be similar to the real world in order to create a lifelike experience—for example, in simulations for pilot or combat training—or it can differ significantly from reality, such as in VR games. In practice, it is currently very difficult to create a high-fidelity virtual reality experience, because of technical limitations on processing power, image resolution, and communication bandwidth. However, the technology's proponents hope that such limitations will be overcome as processor, imaging, and data communication technologies become more powerful and cost-effective over time.

So-called augmented reality (AR) provides a live direct or indirect view of a physical, real-world environment of which elements are augmented (supplemented) by computer-generated sensory input such as sound, video, graphics or GPS data. It is related to a more general concept called mediated reality, in which a view of reality is modified (diminished or augmented) by a computer. As a result, the technology functions by enhancing one's current perception of reality. By contrast, virtual reality replaces the real world with a simulated one. Augmentation is conventionally in real-time and in semantic context with environmental elements, such as sports scores on TV during a match. With the help of advanced AR technology (e.g. adding computer vision and object recognition) the information about the surrounding real world of the user becomes interactive and capable of being manipulated digitally. Artificial information about the environment and its objects can be overlaid on the real world.

Thus, significant enhancements are needed for 3D technology generally, and VR and AR technology specifically, in content generation and/or preparation, multi-format editing of content, and multi-format consumption of content. These enhancements would preferably simplify, and lower the cost of, generating the content, and would greatly enhance the consumption of the content for a broad-base of content consumers.

Unlike current technologies, such as the Oculus Rift technology by Samsung, there is a need for a “passive system” that does not require the consumer to use or own special equipment, such as a specially equipped screen, to achieve an adequate VR or AR experience. Moreover, there is a need to provide for interaction in an improved VR or AR environment to provide an enhanced VR or AR “active system.”

Therefore, the need exists for an engine, system and method suitable to generate, provide and modify, and/or an environment for consumption of, 3D and/or VR/AR content.

### SUMMARY

The present invention includes at least engine, system and method for providing three dimensional content and a viewing experience for same. It is to be understood that both the foregoing general description and the following detailed description are exemplary and explanatory, and are intended to provide further explanation of the invention as discussed hereinthroughout.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention;

FIG. 4 illustrates aspects of exemplary embodiments of the present invention;

FIG. 5 illustrates aspects of exemplary embodiments of the present invention; and

FIG. 6 illustrates aspects of exemplary embodiments of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in similar apparatuses, systems, and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to the disclosed elements and methods known to those skilled in the art.

The present invention provides an engine, system and method for providing three dimensional content and a viewing experience for same. The engine, system and method may thus be used to generate, provide, modify, and/or consume 3D and VR technologies, and may provide such content in an active or a passive system. For example, when coupled with an interactive device or device system, such as Microsoft's Kinect technology, a consumer may interact with the disclosed embodiments of content in an active experience, whereas presently available VR technologies offer only a passive experience, and a passive experience in a “CGI” embodiment at that. That is, the experience of the disclosed embodiments may be 3D or VR content of actual, physical environments, rather than CGI environments. Consequently, the content discussed may be transmitted live or substantially live, such as from a sporting event, and as such may be non-virtual (although it may also be virtual).

The content provided in accordance with this disclosure may provide a panoramic view experience that extends up to approximately 160 degrees to the left and right, and the up and down, which mimics the view-filed of the human eye. More particularly, the disclosure provides, by way of non-limiting example, custom lenses that may interoperate with any digital high definition (HD) camera to capture at 4 times wider than the height aspect ratio. Content captured using these custom lenses may be provided to any available operating system (OS) for previewing, modification, editing, etc., and may ultimately be consumed using viewing glasses, headwear, or the like. For example, viewing glasses may allow for consumption at a minimalistic size, such as slightly larger than typical commercially available 3D glasses, to allow for viewing of the enhanced view filed of the content produced in accordance with the invention. Accordingly, the content may be consumed in a theater, in an IMAX theater, or in home on a television, iPad, or in association with any content provision device or OS.

Although 3D has been around since the 1950's, it was not until the early 2000's that technology made 3D possible at a level that took dominance in the box office. The original 3D technology from the 20th century involved gimmickry such as pointing fingers and balloons floating over the audience, while the 3D of today involves depth of field in an attempt to make the consumer feel like he is more immersed in the action. However, 3D has become a gimmick once again, with the majority of movies converting to 3D through post-production techniques with the result that the 3D effect is virtually lost. When a movie is actually filmed in 3D, the viewer has a much more lifelike experience.

In part due to these factors, the advent of 3D at home has been a failure. The attempt at 3D at home suffered greatly from the lack of industry wide standards, with each manufacturer bringing out non-compatible software and glasses that do no operate with others' products. Most manufacturers are now no longer even making 3D TVs, and DirecTV and DISH Network have stopped carrying 3D signals as well.

Currently, VR is available only as test modules of Oculus Rift. The Oculus Rift, using a Samsung Note display as its display, and its content are 100% gaming and virtual CGI walk-throughs. Sony Morpheus is less functional in this regard, but also only offers gaming and CGI walk-throughs. Neither product is presently available to consumers.

Development and acceptance of 3D and VR/AR technology is also currently hampered by an extremely limited amount of content. Studios are not as likely to spend the extra money on creating “true 3D” because the end result is not that much greater than that obtained by post production conversion, which is significantly cheaper but virtually destroys the experience of 3D. VR content is also limited by the lack of hardware, and the existing hardware's overall size and awkwardness of use—both the Oculus and Morpheus products are essentially helmets that are intended to serve as miniature theatres that provide a closed viewing field that obscures the wearer's ability to observe his surroundings—currently causes disorientation and nausea experienced by many users of these “helmet” type devices.

Even if the hardware were available and content developed, only a limited audience will be able to watch these types of 3D because the hardware is too cumbersome and the content not dazzling enough to merit wearing the required glasses or helmets—not to mention suffering the limitations caused by the nausea and general discomfort of the required hardware. Further, current VR is CGI based, creating a virtual representation of reality, with no present ability to offer live content. That is, VR can only be used with computer generated environments because of the need to manipulate fields and give users control of an environment. The only way this is done presently with “real” video is with hundreds or thousands of cameras, and even then the effect is very limited.

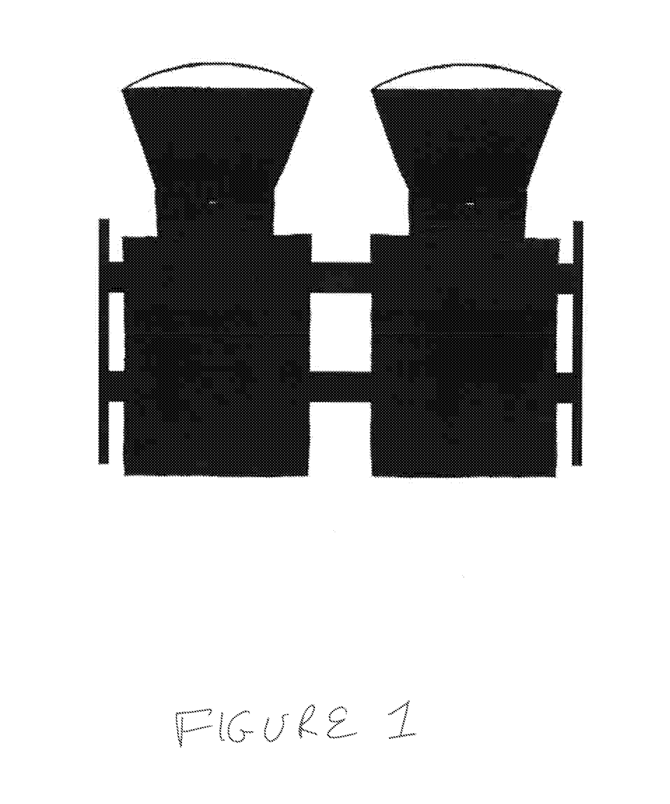

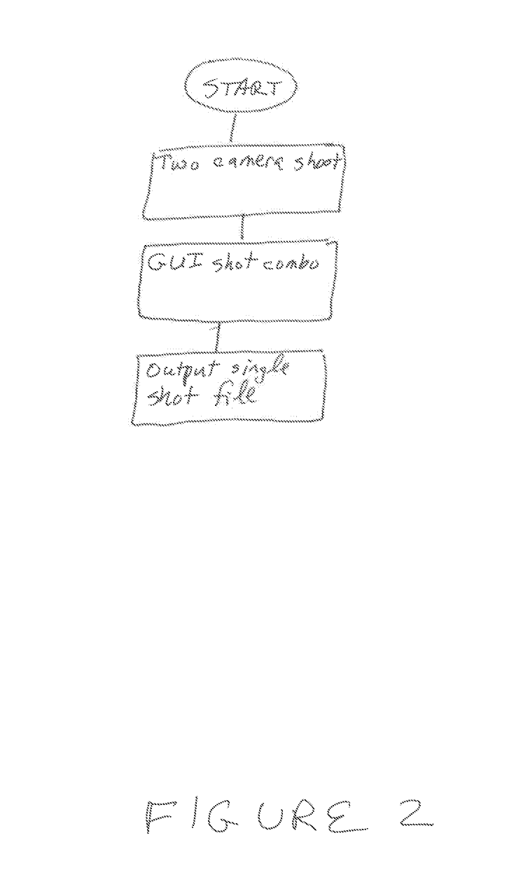

FIGS. 1 and 2 are a diagrammatic representation of a 3D recording system for exemplary generation of content according to the disclosure, and a flow diagram for a method of producing content according to the disclosure. In the illustrations, 3D recordings may be shot utilizing a two camera system, although one camera engineered having two lenses may instead be used. After the content is shot, the two video feeds may be combined in post-production using a graphical user interface, such as proprietary or commercially available video receiving/editing GUIs, for any OS capable of receiving the HD video data feeds, such as Windows, iOS, Andoid, Blackberry OS, DOCSIS, etc. Following the post-production combination, a single file with stereo video may output, in any suitable file output type known to those skilled in the art in light of the discussion herein. A single camera, or both or multiple cameras in a multi-camera system, may preferably employ two lenses, due in part to the fact that two lenses provide superior 3D because of the two sensors used to capture the image, and the camera may be any HD or higher (720 p, 1080 p, 3K, 4K, 8K) camera (the higher the resolution, the higher the quality and more realistic of an image is presented, as will be understood to those skilled in the pertinent arts). The camera(s) may be provided in a custom two-camera rig that holds both cameras and lenses.

The lenses provided may be custom to each brand of camera and classification (A-Mount, E-Mount, etc), as different camera types have different lens mounts, and the lenses provided may specific to those types of mounts, and the rig(s) may likewise be specific to the type of camera used, as this technology is not exclusive to particular brand of camera, and it compatible with every type of professional HD camera available today and for tomorrow. For example, if the Sony NEX-700 4K HD Camera is selected, E-Mount lenses may be provided for a pair of cameras (software may be camera specific as to resolution, and an encoder may automatically detect resolution), and a custom aluminum rig that holds both lenses and cameras may be provided. For example, the encoder may encode using proprietary algorithms for h264 and h265 at dramatically smaller bit rates, with color reproduction and dot by dot accuracy to the original master. Video encoded with the Unity Encoder from Apple, for example, is virtually indistinguishable from Blu-ray video. This encoding renders the two video files into one stereo video file that can be played back on any HD device, as referenced throughout.

The rig may provide approximately 6″ between the two cameras, thereby allowing stereo images to be created at the proper angles while maintaining 8″ wide×2″ tall lenses in pair. Of note, lens size is relevant to sensor size. That is, the larger the sensor, the larger the lens and aperture must be. For example, a consumer unit might have a 4″ by 1″ lens, a “prosumer” unit might have a 1.5″ to 6″ lens, and the professional unit may have the 8″×2″ dimensions referenced above.

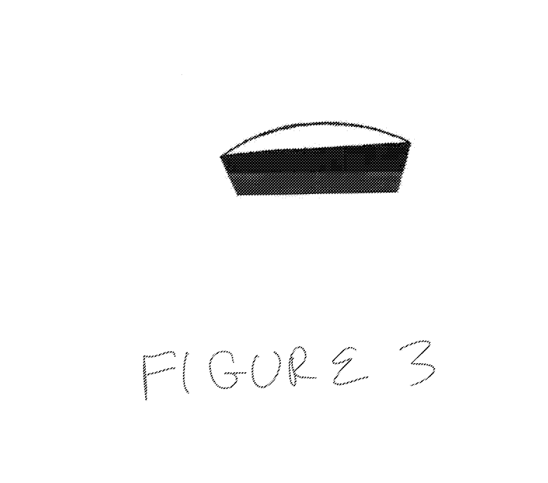

FIG. 3 is an exemplary illustration of a lens employed in an exemplary embodiment of the disclosure. The exemplary lens may be a convex, such as 160 degree convex, fish-eye lens (such that the anamorphic squeeze on the lens to the viewing glasses discussed herein uses anamorphic stretch to correct to 4.0:1 aspect ratio) that is approximately 4 times wider than tall in the image that it captures (of note, 4:1 is a 160 degree field of view, which is exactly what the human eye sees). In short, current 3D is limited to a maximum of 2.5 wider of an image than tall, but the image provided in the instant invention is 4.0 times wider than tall. The lens may be compatible with full frame (i.e., full frame is 35 mm or above quality, which is broadcast standard), ¾ sensors (because prosumer lenses and some mirror-less cameras use ¾ sensors) and a C-type sensor (because most consumer level cameras that shoot 1080 p video use a C size sensor, and each lens may be specific to the type of sensor based on the camera used). The lens has left and right curvature (80 degrees from the ninety degree center point left and right of axis yields a 160 degree total field of view) to substantially or precisely mimic the 160 degree field of view of the human eye, including an up and down periphery that mimics the human eye as well.

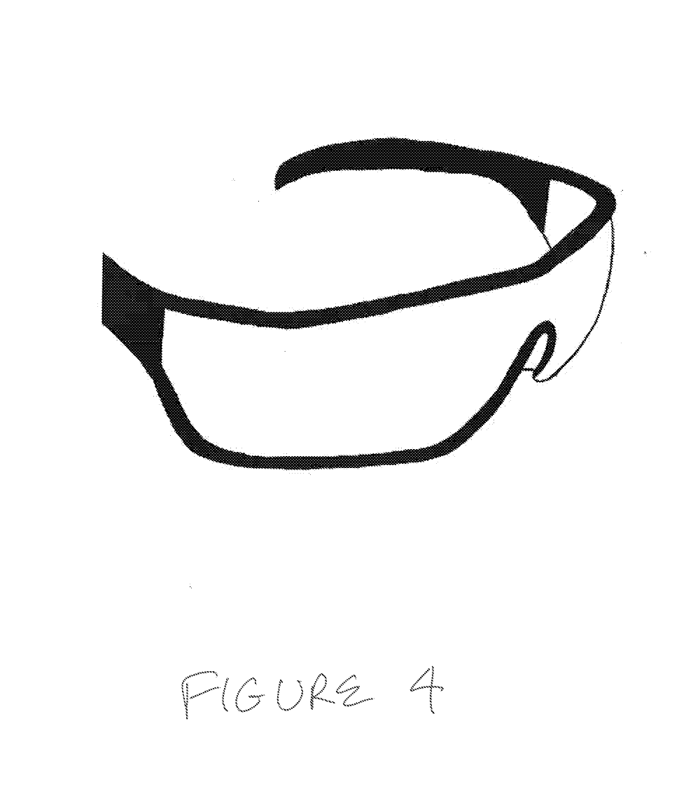

FIG. 4 is a diagrammatic representation of glasses for use in the VR experience discussed herein. The glasses may be designed to mimic the 3D lenses used to capture the content, that is, the glasses may use the opposite angle of refraction and anamorphic stretching to present the image in the proper aspect ratio. For example, the glasses may provide a field of view that is 4 times wider than it is high. For example, a full frame AIPD lens is 8″ wide by 2″ tall. The lens is curved on each side and up and down, like a half dissection of the human eye, in part because the curvature of the image is thus reproduced on the lens to the correct distortion to yield the full periphery of the image. When the glasses are used by the viewer, the result is an engulfing panoramic image that stretches to each corner of the cone of vision of the human eye (i.e., 160 degrees horizontally and vertically, eighty degrees from the vertical and horizontal middle point), and that can be used with any HD display; i.e. HDTV, cinema screen, home cinema screen, tablet, phablet or phone.

Known 3D is limited to 16×9 1.78:1 aspect ratio, which is almost twice as wide of an image as it is tall. Anamorphic squeeze is used to fit an image wider than 1.78 to 1 on a 1.78 to 1 screen. The image is “stuffed” into the box, and anamorphic stretch corrects the aspect ratio. Anamorphic squeeze is used to fit the image onto a 16×9 display, the glasses combined with the rendering software allow for the proper output of the stereo 3D video signal at the presently inventive super wide 4:1 aspect ratio.

Using the passive glasses—which may be typically available wrap around glasses—users may literally be in the middle of the action. The human eye sees 160 degrees in periphery, and with the present glasses, any display will be converted into a 160 degree field of view, three-dimensional display, which is nearly 2.5 times wider than current HD now. Since the glasses are designed based upon the same field of vision as the human eye, when positioned at an optimal distance from the source, the user's display will fill his entire field of vision, thus creating the illusion of total immersion in the content being viewed.

Thereby, the present invention offers complete freedom without being sealed off from the rest of the world, as in a VR headset, and without need of a cord or electronic tether to a computer or a headset. Because the hardware is cheaper for the manufacturer (a pair inexpensive glasses vs very expensive hardware), adoption is improved, so more content will be available. Because it can be used with any device, the consumer can have a great experience at an IMAX theater, or in his hotel room, or at home with his TV or computer screen and anywhere with his iPad/tablet or phone, with no other equipment or technology other than a pair of the presently disclosed glasses. Backward and forward compatibility to other technologies means that a user can play any movie/content on any device.

The present invention also allows content to be viewed in conjunction with a pointing device or camera that tracks movement. The invention also avoids creating motion sickness or an isolation effect, because it does not cut off all surrounding light and environment, and does not require a doubled frame rate. The invention does not require a purchase of content-based active hardware, such as a VR helmet, 3D TV, or even a battery—as the glasses are preferably passive. Accordingly, the user may readily and inexpensively walk virtually through a resort on the other side of the world, take center fire in the battle of Normandy, visit outer space, walk through a patient's heart, or sit on the 50 yard line of a New England Patriots' game, all from the comfort of home.

The present invention may thus be employed in a nearly limitless number of applications. Theater exhibitors, the medical profession, science, travel, sports, gaming, heads up display for computing may use the instant invention. Every manufacturer, movie studio, exhibitor, medical personnel, athlete, tourism board will make use of the instantly disclosed embodiments.

For example, 3D in theaters has become gimmicky, as good projection can offer dimensionality close to that of 3D utilizing good digital projection. But with the present invention, 3D is taken to the next level. Consumers are immersed in the material, with a field of view that mimics the human eye. Picture as big as the room is provided, no matter the screen size. Large format screens get an even larger benefit, as the tremendous light output on a large format screen (IMAX) provides an even more significant experience.

In the medical profession, doctors can take a virtual walk through of a MRI utilizing the instant technology. A doctor can supervise a robotic surgery or a team of surgeons just like he was in the room utilizing the instant technology. Likewise, in the fields of science and research and development, a virtual tour of 3D imaging shot by the Mars Rover, or a ride through the human nervous system, are available using the instant technology.

For travel, consumers can experience a destination before they book. They can walk the streets of Disneyland Paris, or tour the deck of the biggest cruise liner on the planet, all from the comfort of a couch using the instant technology. Travel aspects may interface, such as via the aforementioned software, with Google Street View, for example.

For sports, the instant technology allows a consumer to sit on the fifty yard line of the Patriots versus the Broncos. The consumer can also switch at will between different points of view throughout the stadium.

3D gaming worlds are completely controllable using the presently disclosed technologies. Wearing the glasses, a gamer can sit in the driver seat of a F1 race car, be transported into a modern warfare combat situation, or face her fears as you walk down the halls of a haunted house filled with terror at every turn. The viewer sees everything from her perspective, with the same view field as she sees in the real world.

A heads up display may be readily provided using the disclosed technology. The user's living room is powered by her iPad, and using a camera on her gaming device, computer or tablet, her hands become a mouse and the air is a touch screen.

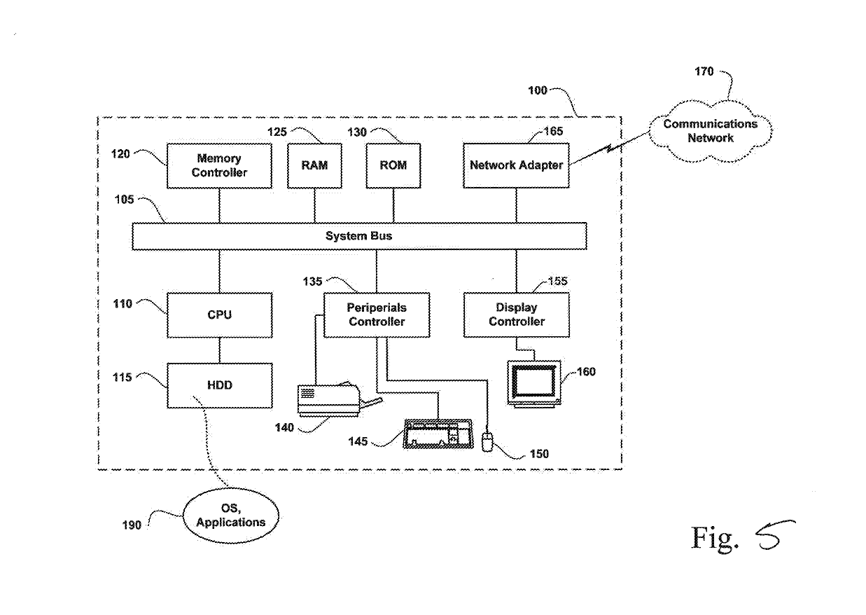

FIG. 5 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs associated with the CPU or communicative with the CPU, such as in the aforementioned cameras and/or associated with the providing of the content to the consumer, and the like. Information, such as computer instructions and other computer readable data, is transferred between components of computing system 100 via the system's main data-transfer path. The main data-transfer path may use a system bus architecture 105, although other computer architectures (not shown) can be used.

System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output, such as the live video and/or GUI discussed above, and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, a cellular or satellite network, or the like. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations. That is, the inventive concepts described herein may be implemented in various computing environments using various components and configurations.

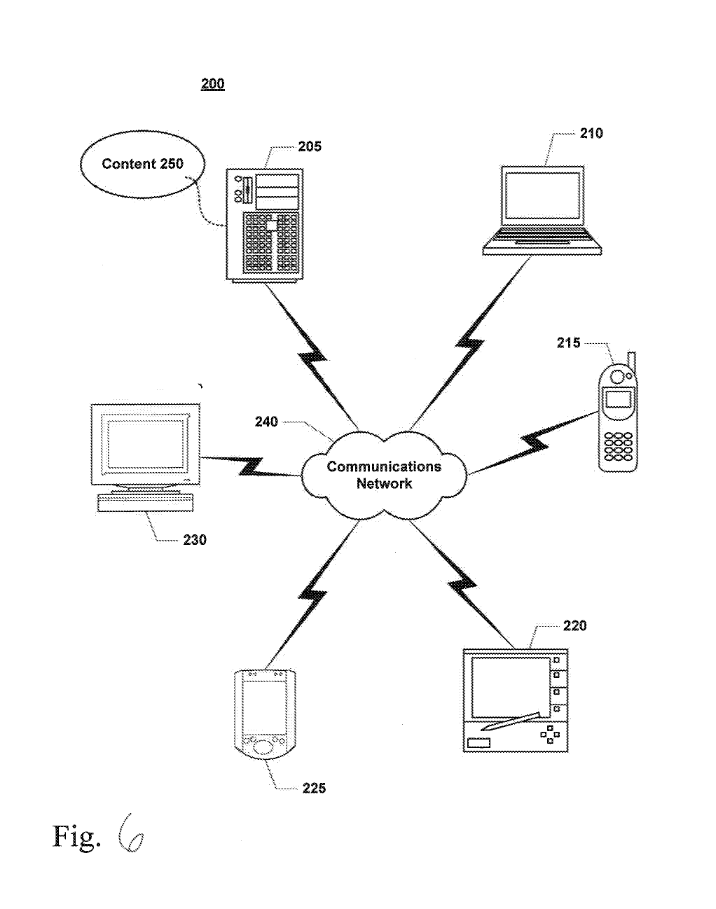

As shown in FIG. 6, computing system 100 can be deployed in networked computing environment 200. In general, the above description for computing system 100 applies to server, client, and peer computers deployed in a networked environment, for example, server 205, laptop computer 210, and desktop computer 230. FIG. 6 illustrates an exemplary illustrative networked computing environment 200, with a server in communication with client computing and/or communicating devices via a communications network, in which the herein described apparatus and methods may be employed.

As shown in FIG. 6, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication/receiving devices such as laptop computer 210, wireless mobile telephone 215, wired telephone 220, personal digital assistant 225, user desktop computer 230, television 231, set top box 233, gaming system 237, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an OS operable to support one or more computing and/or communication applications, such as a web browser (not shown), email (not shown), or the like, to interact with server 205.

Accordingly, a computer-implemented method provided in accordance with the disclosure may include recording desired footage, or transmitting live, utilizing two cameras in 3D, or rendering a CGI gaming environment. Output of video is then combined into a stereo video file using, for example, the software discussed herein. Using the disclosed glasses, the video is then displayed using anamorphic stretch as far as the eye can see.

For live events, for example, two cameras may be used for each viewing point. So, twelve desired locations for a concert would require 24 lenses in 12 dual camera rigs.

A virtual interface, such as coupled with a hand gesture device, i.e., using LED projection centered in a room, may allow the glasses to interface with the camera of a tablet, gaming system, Apple TV or PC to provide a heads up display. Further, for example, a device such as the Kinect device by Microsoft may be used in conjunction with type devices that allow a user to not just be a voyeur but an active participant in the experience for movies, gaming, and a virtual interface.

Thus, as disclosed herein, glasses that allow for viewing of audio visual works produced in accordance with the invention. It would be temporary glasses, such as maybe given out in a theater setting, or maybe more permanent glasses that are brought to a theater, for example. As such, a film placed upon the glasses that allows for viewing of viewing, for example, three dimensional embodiments as set forth herein, may also provide for other functionality, which may be dependent upon whether said glasses are permanent or temporary. By way of non-limiting example, a filtering film may be placed upon the glasses, such as a polarizing film, to allow for the glasses to serve as sunglasses in permanent embodiments. Such a filtering film may, for example, be active or passive.

Other functionality provided by a filtering film or films placed upon the glasses may be agnostic as to whether the glasses are permanent or temporary. For example, the film placed upon the glasses may serve to render the three dimensional viewing capabilities discussed herein. Moreover, the filtering film, such as a polarizing, placed upon the glasses may provide other functionality that may be unique to particular or particular subsets of glasses. By way of example, a visual work may be provided in the theater having embedded therein subtitles or closed captioning in a number of languages. These subtitles or captioning may be variously provided at a number of different viewable frequencies within the visual work, whereby a viewer, upon putting glasses on that filter for or filter out only a certain frequency or frequencies may be enabled to view one of several optional subtitles or closed captioning.

In accordance with the foregoing example, embedded within a movie at a particular frequency, F1, maybe subtitles for the movie in Spanish, wherein the soundtrack of the movie is in English. Accordingly, only those persons viewing the movie having a filtering firm upon their glasses tuned to frequency F1 will be enabled to view the Spanish subtitles of the movie. Others may have filtering capability on their glasses to provide subtitles in other languages, or to provide no subtitles. These variations may be based upon any number of factors that may be embedded individual work, including, but not limited to, frequency, wavelength, phase, or the like. Accordingly, the filtering film placed upon the glasses may be one or more filtering films that provide one or more functions, such as providing 3D viewing capabilities and filtering for closed captioning in the form of a particular language frequency for closed captioning. Thus, the filtering film may be provided with filtering capabilities by anyone or more of a number of methods, including polarization.

The applicability of the instant invention may be included in any number of environments. By way of non-limiting example and in addition to the theater environment discussed herein and above, closed captioning or subtitle capabilities may be variously provided in theme parks, on rides, for in home viewing such as on a television, for smart phones, and the like. In such an exemplary embodiment, glasses handed out at a theme park for the viewing of 3D visual aspects in the course of a theme park ride may be delineated in bins based on the language of the subtitles that will be provided to the rider wearing the glasses. AS such, various languages and capabilities may be provided by the glasses of the instant disclosure at a cost to the user or at no cost to the user. Further, in embodiments in which, for example, the glasses are permanent, and there is a cost to the user, any such cost may be covered by insurance or the like.

The variability in the features provided by the glasses in a visual work viewed using the glasses may be embedded individual work by any known methodology. For example, closed captioning may be embedded at a particular frequency for a particular language in an audio visual work using third party software programs, such as may be provided by software maker Adobe.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A method for providing a virtual three dimensional viewing experience, comprising:
recording video from at least a first camera and a second camera sharing the same view point;
combining the video of the first camera and the second camera to a single video; and
encoding the single video to provide for smaller bit rates as compared to ones of the video of the first camera and the second camera.
